(19) United States
(12) Patent Application Publication
(10) Pub. No.: US 2026/0189616 A1
(43) Pub. Date: Jul. 2, 2026

(54) AUTOMATED LINKING OF ASSETS TO A REAL-TIME AUDIO/VIDEO STREAM

(71) Applicant: International Business Machines Corporation, Armonk, NY (US)

(72) Inventors: Amber Morgan, Dallas, TX (US); Logan Bailey, Atlanta, GA (US); Zachary Augustus Silverstein, Georgetown, TX (US); Jeremy R. Fox, Georgetown, TX (US)

(21) Appl. No.: 19/008,494

(22) Filed: Jan. 2, 2025

(51) Int. Cl. H04L 65/403; G06F 16/43; G06F 40/289

(52) U.S. Cl. CPC H04L 65/403; G06F 16/43; G06F 40/289

(57) ABSTRACT

Mechanisms are provided to automatically identify referenced assets in real-time streaming communications and automatically identify, retrieve, and present these assets during the real-time streaming communication. The mechanisms obtain, in real-time, a textual representation of a user's input during the real-time streaming communication. As part of a background process to the real-time streaming communication, computer natural language processing is executed on the textual representation to identify key terms or key phrases from the textual representation. The computer natural language processing is specifically configured to identify key terms/phrases corresponding to references to assets. As part of the background process, one or more search queries are generated and executed to search for a matching asset based on the identified key terms/phrases. As part of the real-time streaming communication, the matching asset is presented to participant computing devices of the real-time streaming communication.

### BACKGROUND

The present application relates generally to a data processing apparatus and method and more specifically to a computing tool and computing tool operations/functionality for automated linking of assets to a real-time audio/video conversation stream.

Real-time communications over data networks is rapidly replacing conventional analog conversation systems, such as wired telephone systems and the like. For example, Voice-over-Internet-Protocol (VOIP) systems allow real-time audio communications to be performed, similar to a telephone system, but over a data network. Web conferencing capabilities are now increasingly used to facilitate communications both in personal and business environments using both audio and video capabilities of computer equipment. Moreover, these web conferencing mechanisms provide capabilities such as screen sharing, real-time textual chat interfaces, and the like, through which various types of content may be shared amongst the web conference participants.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises obtaining, in real-time, a textual representation of a user's input during a real-time streaming communication via a real-time streaming communication application. The method further comprises automatically executing, as part of a background process to the real-time streaming communication, computer natural language processing on the textual representation to identify one or more key terms or key phrases from the textual representation. The computer natural language processing is specifically configured to identify key terms or key phrases corresponding to references to assets. The method also comprises automatically generating, as part of the background process, one or more search queries to search for a matching asset based on the identified one or more key terms or key phrases. Moreover, the method comprises automatically executing, as part of the background process, the one or more search queries to identify a matching asset. In addition, the method comprises automatically presenting, as part of the real-time streaming communication, the matching asset to participant computing devices of the real-time streaming communication.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram of the primary operational components of a real-time asset linking conversation system in accordance with one illustrative embodiment; and

FIG. 3 is a flowchart outlining an example operation of a real-time asset linking conversation system in accordance with one illustrative embodiment.

### DETAILED DESCRIPTION

The illustrative embodiments provide an improved computing tool and improved computing tool operations/functionality for automated linking of assets to a real-time audio/video conversation stream. As noted above, data network based communication systems are a primary technology for human-to-human communications, allowing both audio and video data to be streamed between participant computing devices. Such communication, e.g., Voice-over-Internet-Protocol (VOIP), web conferencing applications, and the like, greatly increases the ability for humans to communicate over large distances with minimal expense and with increased capabilities for sharing information, such as by allowing participants to share their screens, add textual content to chat interfaces, manually provide hyperlinks and the like in the textual chat for use by other participants, and the like.

It has been recognized that during such real-time data network based communications, e.g., web conferences, webchats, or any other real-time data streaming based communication, participants may reference assets, e.g., audio files, video files, data files, electronic documents, web pages, or the like, which they are discussing or wish to share with the other participants during the real-time streaming communication. If a participant knows of an asset or has an asset they want to share, there are multiple steps that they must go through to find the correct searching platform to find the correct asset, download it if it is not already downloaded and local to the participant's computing device, and then manually insert it into the communication stream. This may require, for some assets, that the participant be given permission to share content by the host of the real-time streaming communication, the participant accepting and going through the process of enabling screen sharing, bringing up the asset on their own computing device, and then sharing the image of the asset via the screen sharing process while the participant manipulates the asset on their own computing device. For other assets, the participant must obtain the asset locally and then manually paste or insert it into an interface, e.g., chat interface or the like, of the communication service interface so that it can be accessed by other participants of the real-time streaming communication.

The process of finding the asset may require use of a file explorer application and local search engine for finding assets local to the participant, a web browser application and search engine for finding assets that are not local to the participant and may be hosted by other computing devices accessible via the Internet or other data network, or any number of other applications and services outside of the real-time communication application/service. Moreover, this process is largely a manual process that relies on the participants knowing what assets they want to link to or share in the real-time communication and going through the multi-step manual process to find and link/share those assets through the real-time communication application/service interfaces. This introduces additional burdens on the participants and often leads to delays and inefficiencies in the real-time streaming communications as participants pause the conversation being conducted to go and find and link/share the assets that they want to be part of the conversation and accessed by the other participants. This may lead to frustration on the part of the participants.

The illustrative embodiments provide a computing tool and computing tool operations/functionality that is specifically directed to solving these issues present in existing real-time streaming communication computing systems. The illustrative embodiments operate to improve the efficiency of real-time streaming communications, such as web conferencing communications, via participant computing systems and corresponding real-time communication applications, by providing automated tools and processes for identifying assets, obtaining the assets, and linking or sharing the assets with the participants of the real-time streaming communication without requiring human intervention. The illustrative embodiments implement artificial intelligence (AI) and computer natural language processing (NLP) mechanisms to automatically identify the assets that are being referenced during the real-time streaming communication based on the context of the real-time streaming communication.

The illustrative embodiments may then automatically perform operations to retrieve the identified assets from local and/or non-local locations. This may involve searching locally for the asset initially and then if the asset is not present in a local store, searching for the asset in non-local sources via search mechanisms. If the asset is not stored locally, then the non-local asset may be downloaded and/or a link to the storage location at a non-local source may be obtained.

The illustrative embodiments may then automatically, or semi-automatically, link and/or share the asset with the participants of the real-time communication by automatically enabling display and screen sharing to present images of the asset, inserting links to the asset in a chat interface, distributing the asset to the participant computing systems, or the like. In some cases this is done automatically, but in other cases, a participants' verification of their desire to link/share the asset may be obtained first before then automatically performing the operations needed to link/share the asset with the other participants. Thus, the illustrative embodiments reduce the manual tasks required to identify, obtain, and link/share assets during real-time communications and as a result minimize the introduction of human error into the process of linking/sharing assets.

With the mechanisms of the illustrative embodiments, participants can engage with each other through the automated real-time asset identification and linking/sharing capabilities of the illustrative embodiments, in a simultaneous manner with the continuing of the audio/video communication between the participants. That is, the participant who is referencing an asset or who wishes to link/share an asset does not need to manually perform the series of steps to do so, as this burden is offloaded to the automated mechanisms of the illustrative embodiments. Reducing time and human manual effort to send or provision access to an asset allows for a higher quality and more streamlined experience when participating in collaboration or knowledge transfer via real-time streaming communications.

For example, consider a scenario in which a first participant, Jessica, is working with a second participant, Jeremy, on the latest sales report number for the quarter. They are discussing a spreadsheet, e.g., Quarterly Sales Report, that was upload from Jessica into a remote data storage and sharing service, such as IBM BOX (available from International Business Machines (IBM), Corporation of Armonk, New York), or the like. Jessica specifically calls out the spreadsheet by the name of the asset (e.g., “In this quarter's Quarterly Sales Report . . . ”) during her audio communication with Jeremy. The illustrative embodiments comprise mechanism that are monitoring the real-time streaming communication, e.g., the web conference between Jessica and Jeremy, using various technologies such as Automated Speech Recognition (ASR), Speech-to-Text translation, computer Natural Language Processing (NLP), and the like, to perform real-time analysis of the monitored real-time streaming communication. With this real-time monitoring, the mechanisms of the illustrative embodiments autonomously identify the asset “Quarterly Sales Report” as having been referenced during the communication, searches for this asset, and prepares the link and provides that asset to Jeremy in a real-time manner.

In identifying the mention of the asset, the real-time monitoring tools are specifically attuned to the participant, e.g., Jessica, and are specifically configured to the particular vocabulary used by Jessica during such real-time streaming communications. For example, the mechanisms of the illustrative embodiments may be attuned to Jessica mentioning the following critical key phrases, to aid in identification of the asset: CIO Sales Report 3Q 2022, BOX file, Uploading, and recent management questions on the third quarter sales report for 2022. Thus, the artificial intelligence computer models and natural language processing are trained and configured to recognize Jessica's speech mentions of terms/phrases that are indicative of references to assets. Thus, the ASR computer models recognizes the terms spoken by Jessica and translates those into textual representations of her speech, while the NLP mechanisms process the textual representations to identify the mentions of references to assets.

In response to recognizing a reference to an asset, the mechanisms of the illustrative embodiments are automatically executed to perform searches to find the mentioned asset locally and/or non-locally. The mechanisms of the illustrative embodiments provide both the spreadsheet file, “Quarterly Sales Report,” and the downloadable location (the link) for the asset that Jessica is conversing about. This allows Jeremy to spend less time trying to find the asset and more time working with Jessica over the real-time streaming communication, e.g., web conference, regarding improving the sales forecast for the quarterly report for their management team.

The searching for the asset may involve searching the local storage of Jessica's computing device using a file explorer or other file searching algorithm and interface. In particular, the search interface may be automatically populated with the textual term(s) for the asset recognized from the textual representation and the search initiated. Matching assets may be identified using a textual similarity analysis on asset descriptions, e.g., filenames, metadata, and the like, with the textual term(s) of the search query. A degree of matching may be calculated using any suitable similarity metrics, e.g., cosine similarity or the like. In some cases, the textual term(s) and the asset descriptions may be represented as vector embeddings and the similarity may be determined using vector similarity metrics. A top ranking match may then be selected if a confidence in the match results is sufficiently high, e.g., equal to or above a predetermined threshold degree of matching.

If a matching result having a sufficiently high confidence is not found locally, then a non-local search may be initiated by interfacing with a search engine or search service accessible via one or more data networks. For example, a search may be initiated on a local area network (LAN) with which Jessica's computing device is associated, e.g., an organization's internal network, or even a wide area network (WAN) search may be performed, e.g., an Internet search may be initiated via a web browser and an Internet search engine. The searches may be performed in accordance with a tiering structure where the scope of the search is iteratively expanded. For example, the searches may be first to the local storage of the participants' computing device, then expanded to sources on the same LAN, then to a cloud based corpus or repository associated with the organization with which the participant is associated, and then to a more general WAN. These searches are performed automatically “behind-the-scenes” while the participant continues on with their real-time streaming communication uninterrupted.

The searches are performed using the textual term(s) for the asset recognized from the textual representation of Jessica's speech input. If a sufficiently high matching result is not found, then the asset may not be presented during the real-time streaming communication, and the inability to find the asset may be logged or a notification output to Jessica's computing device indicating that the asset could not be found. Alternatively, a listing of the top X matches from the local and/or non-local searches may be presented to Jessica via a notification interface, e.g., pop-up window, private chat interface, or the like, to inform Jessica of the best matches and provide her with the ability to select a match from the top X for real-time streaming presentation, adding to an asset listing for subsequent follow-up after the communication terminates, or the like.

In some illustrative embodiments, in order to make the identification of a matching asset more likely to result in a correct match, a historical asset log data structure may be maintained that stores a log of a user's asset accesses and mentions in communications over a predetermined historical period of time. This historical asset log data structure may be searched first for a matching asset prior to expanding the search to the local and then non-local searches. Thus, in this way, the searching may be focused on the historical asset log data structure and then expanded in an iterative manner in an attempt to find the asset being referenced by the participant in the real-time streaming communication.

The illustrative embodiments have monitoring engines that monitor user interactions with assets through their filesystems and the like, and monitor communication applications of the user's computing device for mentions of assets in the audio and/or textual communications. The monitors identify the other parties with which communications are performed and logs the asset mentions in communications with those other parties. The monitors also log which assets are actually accessed by the user. In order to avoid using asset accesses/mentions that may be stale and may add noise to the search results, the historical asset log data structure may be limited to a predetermined historical time period, such as a few days, a week, or the like.

The historical asset log data structure helps to focus the searches to a particular sub-set of assets that are most likely the ones referenced by the user in the real-time streaming communication. The historical asset log data structure stores the historical references to a past asset that was already utilized or referenced in communications by the owning user. In this way, the user can reference a past event without having to repeat the definition, actual description, or talking through the asset path once again. To illustrate this further, consider a scenario where Jessica and Jeremy are discussing patents and the patenting process. Jessica mentions something to Jeremy about a link she had spoken with Zach about last week. This asset mention, the mention of the other party (Zach), and the time frame (last week), may be identified Jessica's statement and extracted using the ASR and NLP mechanisms. These features may be used to search the historical asset log data structure where entries specifying Zach as another party and having a timestamp within the last week, may be identified and used as a basis for performing the search. The search may further be performed using term(s) extracted from the textual representation of Jessica's statement to find a match. For example, it may be found that Jessica was talking with Zach a week agon about a website “Patent Life Cycle”, that describes the patenting process. In response to finding this match, the matching website URL may be added to an appropriate portion of the interface of the real-time streaming communication.

In some illustrative embodiments, in addition to, or alternative to, the real-time streaming presentation of the assets via the real-time streaming application, the assets mentioned during the real-time streaming communication may be compiled into a listing and a data structure and staged for post communication follow-up and access by the participants after the communication has concluded. That is, in some illustrative embodiments, a listing of assets mentioned/shared during the real-time streaming communication, along with either copies of, or links to, these assets, may be maintained and distributed to each of the participants after the communication is terminated. This allows participants to recall which assets were discussed and be able to perform follow-up operations with regard to these assets.

In some illustrative embodiments, in addition to the automatic detection of, searching for, and presentation of assets during real-time streaming communications, the illustrative embodiments further provide an automatic screen capture capability that automatically captures screen images of the presentation of an asset during the real-time streaming communication and automatically generate a set of images, slides, or the like, of the assets. For example, if a user shares a screen during the communication and accesses a document, a screen capture of the document may be captured and stored as an image/slide in an asset data structure that stores the screen captures for the real-time streaming communication. As the sharing participant manipulates the shared document, e.g., transitions to another page of the document, additional screen captures may be generated and stored to the asset data structure. This asset data structure may then be distributed to the participants after the real-time streaming communication terminates.

Thus, the illustrative embodiments provide an improved computing tool and improved computing tool operations/functionality to automatically identify references to assets, search for those assets, and present those assets during a real-time streaming communication between a plurality of participants. The illustrative embodiments allow participants to continue their real-time streaming communications without interrupt while still being able to share referenced assets with the participants. In some illustrative embodiments, the assets are identified, retrieved, and presented automatically and simultaneously with the real-time streaming communication. In some illustrative embodiments are compiled for follow-up operations after the real-time streaming communication has terminated. As a result, the delays and frustration associated with having to manually identify and retrieve assets is avoided.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides capabilities and functionality for monitoring a real-time streaming communication for references to assets, automatically identify, search for, and retrieve those assets, and present those assets to participants in the real-time streaming communication. The improved computing tool implements mechanism and functionality, such as the automated real-time asset identification and sharing (ART-AID) engine, which cannot be practically performed by human beings either outside of, or with the assistance of, a technical environment, such as a mental process or the like. The improved computing tool provides a practical application of the methodology at least in that the improved computing tool is able to minimize issues associated with manual asset identification and retrieval by providing automated computing functionality to automatically identify, search for, retrieve, and share assets based on participants mentions of assets during real-time streaming communications, such as web conferences, VOIP, or other data network based communications.

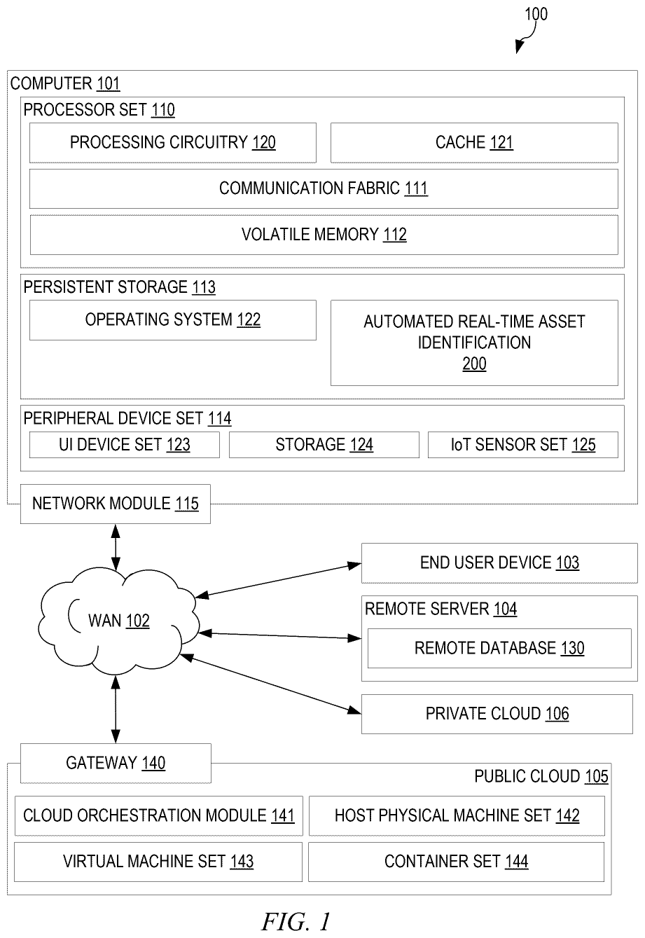

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as automated real-time asset identification (ART-AID) engine 200. In addition to ART-AID system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ART-AID system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in ART-AID system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in ART-AID system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement an ART-AID system 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated monitoring of real-time streaming communications, identification of mentions of assets, searching for, retrieval of, and sharing of assets during the real-time streaming communications and/or after termination of the real-time streaming communications.

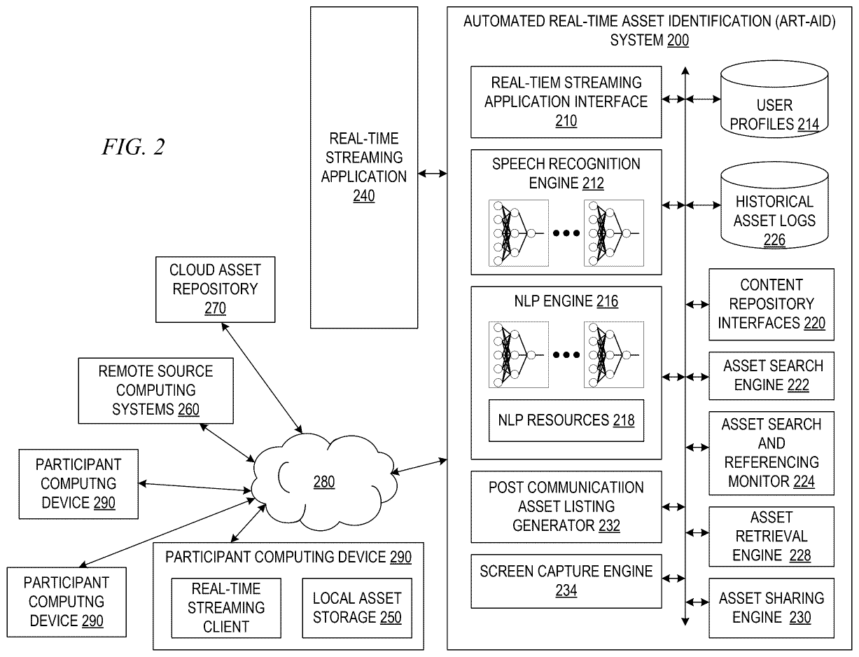

FIG. 2 is an example block diagram of the primary operational components of a real-time asset linking conversation system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that asset sharing is performed in association with real-time streaming communications, and providing a specific solution that implements automatic speech recognition (ASR), natural language processing (NLP), automated searches of data repositories and data networks for assets, automated retrieval of the assets from their storage locations, and automated presentation and/or distribution of the assets to participants in the real-time streaming communication, which cannot be practically performed by human beings as a mental process and is not directed to organizing any human activity.

As shown in FIG. 2, the ART-AID system 200 comprises a real-time streaming application interface 210, speech recognition engine 212, user profile storage 214, Natural Language Processing (NLP) engine 216, NLP resources 218, content repository interfaces 220, asset search engine 222, asset access and referencing monitor 224, historical asset log storage 226, asset retrieval engine 228, asset sharing engine 230, post communication asset listing generator 232, and screen Capture engine 234. The ART-AID system 200 operates in conjunction with real-time streaming application 240, which may be a web conference software, Voice-over-Internet-Protocol (VOIP), textual chat software, or other data based communication system for performing real-time streaming communication over one or more data networks 280. For purposes of the description of the illustrative embodiments herein, it is assumed as an example that the real-time streaming application 240 is a web conferencing application through which audio and video data is shared between multiple participants of the web conference. The participants utilize their own participant computing devices 290 to engage in the real-time streaming communication, with these participant computing devices 290 comprising the requisite microphones, digital cameras, and the like, to capture audio/video data which is then streamed to the other participant computing devices 290 engaged in the real-time streaming communication, e.g., the web conference.

One participant, referred to herein as the “user”, is a participant that mentions an asset during the real-time streaming communication of the web conference, causing the mechanisms of the illustrative embodiments to operate. It should be appreciated that while a single “user” will be discussed in the following description, each participant in the real-time streaming communication, at various times, may be a “user” when they make reference to assets. Thus, the operations of the ART-AID system 200 may be performed with each individual participant. Hence, in some illustrative embodiments, the ART-AID system 200 may be downloaded and installed on each individual participant computing device 290 and may operate in conjunction with the real-time streaming communication application executing on the participant computing device 290. In other illustrative embodiments the ART-AID system 200 is provided on one or more centralized computing systems, such as being part of a cloud service or the like. FIG. 2 represents the ART-AID system 200 as a separate entity from the participant computing devices 290, but this is only intended as an example and is not intended to be limiting on the configuration of the ART-AID system 200.

The real-time streaming application interface 210 provides a data communication interface through which the ART-AID system 200 is able to communicate data with the real-time streaming application 240. For example, the interface 210 allows the ART-AID system 200 to monitor the audio/video data of the web conference, in real-time, as well as provide data to represent automatically found and retrieved assets to participants of the web conference via one or more portions of the web conference user interface.

The speech recognition engine 212 provides artificial intelligence (AI) computer models and logic that are trained (through machine learning training processes) and configured to analyze data regarding audio captured during the web conference and convert the audio to textual representations. Any suitable known, or later developed, automated speech recognition (ASR) technology may be used for this purpose and thus, a more detailed explanation of how audio is converted to text is not provided herein. However, it should be appreciated that the speech recognition engine 212 may be customized to the particular user via a user profile stored in the user profile storage 214. The particular user may be identified based on login information provided to the real-time streaming application 240 and/or the ART-AID system 200.

That is, when a user registers with the ART-AID system 200, the user provides user identification information and may be prompted to configure the system to their particular voice patterns by speaking key words and phrases. In accordance with the illustrative embodiments, these key words and phrases may be specific to words and phrases known to be indicative of a reference to an asset, e.g., open, access, file, spreadsheet, document, web page, link, etc. Thus, the ASR mechanisms may be specifically configured to the user's specific way of speaking. Moreover, the user profile may be updated dynamically as the user interacts with the real-time streaming application 240 and speaks particular words/phrases followed by accessing of an asset. Thus, the user profile may be a dynamic user profile and provides dynamic configuration of the speech recognition engine 212 for the particular user.

As audio is detected and translated into textual representations by the speech recognition system 212, the textual representations are input to the NLP engine 216 which operates on these textual representations based on NLP resources 218. The NLP resources 218 may be dictionaries, ontologies, synonym lists, antonym lists, and user historical conversation logs for the particular registered users, for example. The NLP engine 216 comprises AI computer models and logic that is specifically trained (through machine learning processes) and configured to interpret natural language content of the textual representations and identify key features from the natural language content that permit the NLP engine 216 to obtain an understanding as to what is being conversed about. This may involve performing named entity recognition (NER), sentiment analysis, focus determination, key term/phrase identification, and the like.

In some illustrative embodiments, the NLP engine 216 comprises one or more neural networks, transformer-based computer models, support vector machines, or the like, that are specifically configured to recognize terms/phrases related to references to assets in natural language content. These AI computer models may be specifically trained through machine learning processes which may involve using training examples that are labeled with ground truth data specifying the particular terms/phrases that the AI computer model should recognize in the given training example, have the AI computer model process the training example and generate results, compare those results to the corresponding ground truth to generate a loss or error, and then apply a machine learning algorithm to modify operational parameters of the AI computer model so as to reduce the loss/error. This may be repeated over a plurality of training examples and a plurality of iterations or epochs until a convergence criterion is reached, e.g., predetermined number of iterations met or a performance metric meeting or exceeding a desired performance threshold.

In some illustrative embodiments, the NLP engine 216 may comprise a language model (LM) or fine-tuned large language model (LLM), for example. In the case of an LM/LLM, the model may be fine-tuned to the particular task of identifying references to assets from the textual representation generated by the speech recognition engine 212, for example. The NLP engine 216 may automatically generate prompt inputs to the LLM with a specified task, such as “identify references to assets in the following context . . . ” with the context being the particular textual representation provided by the speech recognition engine 212. The prompt may further specify the format of the output, e.g., a listing of terms/phrases indicative of references to assets.

As mentioned above, the NLP resources 218 may comprise a historical conversation logs. These conversation logs may server as additional training examples for refinement training of the AI computer models of the NLP engine 216 and customization to the particular user. That is, the AI computer models may be pre-trained using generally applicable training examples that are applicable to a plurality of users. Thereafter, the AI computer models may be fine-tune trained to the particular user's personal historical references to assets as represented in the historical conversation log. The conversation logs may be segmented into individual statements which are then labeled as to whether they reference an asset or not and what the references to the asset are, if any. These statements may each be a fine-tune training example, representing both positive and negative training examples for fine-tune training the AI computer model. Thereafter, the configuration information for the AI computer model may be stored in association with the user profile in the user profile storage 214 such that it may be retrieved and used to configure an instance of the AI computer models of the NLP engine 216 for the particular user.

The NLP engine 216, based on the natural language processing operations, generates a listing of terms/phrases corresponding to an asset reference in the textual representation generated by the speech recognition engine 212, if there are any. These terms/phrases are used as a basis for generating search queries via the asset search engine 222. The asset search engine 222 comprises computer logic to generate search queries, such as Structured Query Language (SQL) queries that are applied against a database, text search queries processed via a search engine, or the like. The asset search engine 222 may interface with one or more search engines or search services that may be local or remote and may interface with any necessary application programming interfaces (APIs), applications, web browsers, and the like, to facilitate the performance of searches for the asset referenced in the textual representation, as determined by the NLP engine 216.

The asset search engine 222 may generate query language queries, textual search queries, LM/LLM prompts, or the like, to perform a search for the asset, as well as perform operations to search a user's specific historical asset log in the historical asset log storage 226. The historical asset log storage 226 stores a historical asset log that comprises entries specifying details of assets accessed and/or referenced by the user of a predetermined historical period of time. These accesses may be actual reading/writing of assets and loading of assets into applications for rendering, such as in the case of web pages, electronic documents, spreadsheets, source code, image/audio files, executable files, various types of data structures, and the like. The asset search engine 222. The historical asset log may further include textual content corresponding to the user's references to assets in their communications, such as may be identified by the NLP engine 216, i.e., as the NLP engine 216 recognizes references to assets, log entries corresponding to these references may be maintained in the historical asset log storage 226.

The accesses and references to assets may be identified via one or more monitoring agents of the asset access and referencing monitor 224. The monitoring agents monitor processes and communications of the user's participant computing device 290 and log the accesses to assets. Moreover, the asset access and referencing monitor 224 works in conjunction with the NLP engine 216 to store references to assets identified by the NLP engine 216.

The asset search engine 222 may operate to perform the searches in a hierarchical manner with an increasing scope at each level of the hierarchy. For example, the asset search engine 222 may first search for the referenced asset in the historical asset log storage 226. If a sufficient match is not found, then the search may be expanded to a local storage of the user's participant computing device 290. If a sufficient match is again not found, the search may be expanded to sources on a local area network and/or in a cloud storage associated with the user and/or user's organization. If a sufficient match is not found again, the search may again be expanded to a wide area network, such as the Internet, or the like. A “sufficient” match is measured by a level of matching between the description, filename, and/or metadata of the asset and the particular search criteria, e.g., the terms/phrases searched for using the search queries. A threshold level of matching may be predetermined such that sufficiency is determined when the threshold is met or exceeded.

The information about assets used to match to search queries may be obtained through content repository interfaces 220 which provide access to assets and their metadata, as well as any stored descriptions of the assets. If no asset is found from the searches that has a sufficient level of matching, then a corresponding notification may be output to the user via their participant computing device 290 to indicate that the mentioned asset cannot be identified. In such a case, the user may have to resort to a manual search and retrieval process. If there is no matching asset, yet some assets are within a given tolerance of the required threshold of matching, then a listing of the assets that are within that threshold may be presented to the user for user selection of the asset they consider to be matching, if any. In response to a user input selecting a listed asset, the selected asset may then be considered the matching asset and further operations for retrieval and presentation may be performed.

Assuming that a sufficiently matching asset is identified through the searches performed by the asset search engine 222, the asset retrieval engine 228 comprises logic for retrieving the asset from its location, if needed, and/or obtaining the necessary links for accessing the asset. Once the asset and/or links to the asset are retrieved, the asset sharing engine 230 provides appropriate user interface elements to present the asset and/or the links to the asset to the participants in the web conference. This may involve automatically enabling screen sharing and then sharing a screen that presents the asset, e.g., a document, web page, or the like. This may involve inserting the link into a chat interface of the web conference. This may involve downloading the files and distributing them to the participant computing devices 290 of the participants as a push operation to push the files to these devices 290. In some cases, separate electronic communications may be automatically generated and transmitted to the participant computing devices 290, such as electronic mail messages, text messages, or the like, through channels separate from that used to perform the real-time streaming communication. Of course, these are only examples of the types of sharing of assets that may be implemented, and any other sharing capabilities may be used to share the asset without departing from the spirit and scope of the present invention.

In some embodiments, the retrieved assets and/or links to the assets may be stored in an asset listing data structure for distribution to participants after the real-time streaming communication is concluded. That is, the post communication asset listing generator 232 may generate this listing of assets and/or their links and transmit this listing to the participants in separate communications or data transfers after the session with the real-time streaming application 240 is terminated. In some cases, this may further include screen captures that are generated by the screen capture engine 234 during the web conference in response to users sharing information via screen sharing or other mechanisms of the web conferencing software that enable sharing of assets.

Thus, in addition to, or alternative to, the real-time streaming presentation of the assets via the real-time streaming application 240, the assets mentioned during the real-time streaming communication may be compiled by the post communication asset listing generator 232 into a listing and a data structure and staged for post communication follow-up and access by the participants after the communication has concluded. This allows participants to recall which assets were discussed and be able to perform follow-up operations with regard to these assets.

Moreover, the screen capture engine 234 provides an automatic screen capture capability that automatically captures screen images of the presentation of an asset during the real-time streaming communication and automatically generates a set of images, slides, or the like, of the assets. For example, if a user shares a screen during the communication and accesses a document, a screen capture of the document may be captured and stored as an image/slide in an asset data structure that stores the screen captures for the real-time streaming communication. As the sharing participant manipulates the shared document, e.g., transitions to another page of the document, additional screen captures may be generated and stored to the asset listing data structure generated by the post communication asset listing generator 232. This asset listing data structure may then be distributed by the post communication asset listing generator 232 to the participant computing devices 290 after the real-time streaming communication terminates.

It should be appreciated that which options to utilize when identifying, retrieving, and sharing assets may be specified by the user in their user profile stored in the user profile storage 214. For example, the user may specify that they would like to only share the link to an asset and not distribute the asset itself. They may specify that they wish to insert the link into a chat interface of the web conferencing application. They may specify that they would rather provide the link in a communication transmitted after the session with the web conferencing application is terminated. They may specify that they would like automatic screen captures of shared documents. Any of the above options discussed above in the various illustrative embodiments may be enabled/disabled via the specifications in a user's user profile. Hence, when the user logs onto the ART-AID system 200, the user's instance or session with the ART-AID system 200 may be specifically configured in accordance with the user's user profile retrieved from the user profile storage 214.

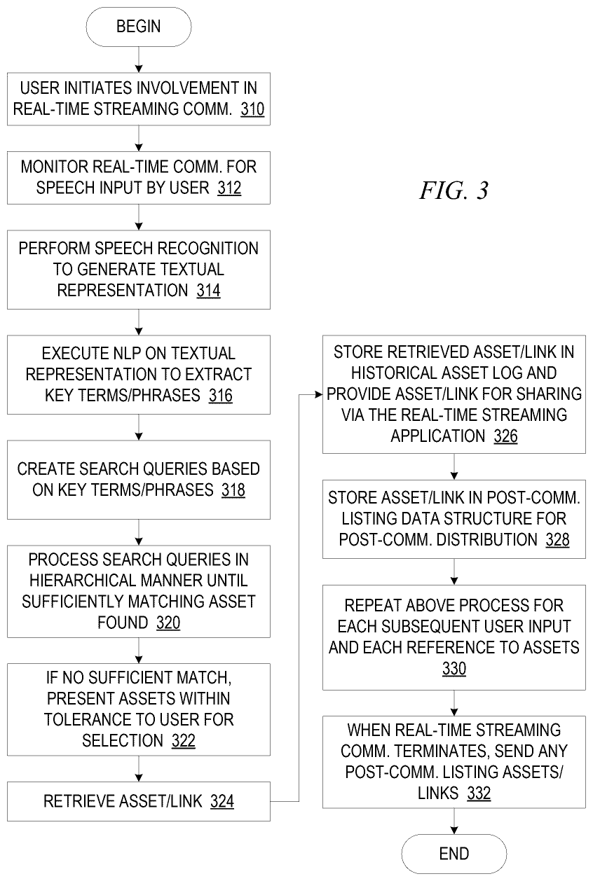

FIG. 3 is a flowchart outlining an example operation of a real-time asset linking conversation system in accordance with one illustrative embodiment. It should be appreciated that the operations outlined in FIG. 3 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 3, and may, in some cases, make use of the results generated as a consequence of the operations set forth in FIG. 3, the operations in FIG. 3 themselves are specifically performed by the improved computing tool in an automated manner.

The operation outlined in FIG. 3 assumes that a user has already registered with the real-time streaming communication application and/or the ART-AID system 200 of the illustrative embodiments. This may include providing voice print information for terms/phrases associated with asset references, as discussed above, as well as any other configuration of the ART-AID system 200 for particular use by the user. This may include setting preferences for automatic identification, retrieval, and sharing of assets during real-time streaming communications, for example.

As shown in FIG. 3, the operation starts by the user logging into or otherwise initiating involvement in a real-time streaming communication via a real-time streaming communication application (step 310). The real-time streaming communication is monitored for speech input by the user (step 312) upon which a speech recognition operation is performed to generate a textual representation of the detected speech (step 314). Natural language processing of the textual representation is performed to extract key terms/phrases specific to references to assets (step 316). The key terms/phrases are used as a basis for creating one or more search queries (step 318). The search queries are then processed in a hierarchical manner with an expanding scope at each hierarchy until a sufficiently matching asset is identified (step 320). The hierarchy may comprise a historical asset log initially, followed by a local storage, sources of a local area network, cloud storage associated with the user and/or user's organization, and then a wide area network, for example.

If a sufficiently matching asset is not found, then any assets that are within a tolerance of the sufficiency threshold may be presented to the user for selection and/or a notification may be presented to the user indicating the inability to identify a sufficiently matching asset (step 322). If a sufficiently matching asset is identified, or the user selects an asset from the presented options, the asset is then retrieved and/or its link is retrieved (step 324). The retrieved asset and/or link are stored in a historical asset log and may be provided for asset sharing via the real-time streaming communication application (step 326). In some cases, the retrieved asset and/or link may be stored in an asset listing for post real-time streaming communication distribution (step 328). The process continues while the real-time streaming communication, e.g., web conference, is ongoing with the process repeating for each speech input and identified references to assets in the speech (step 330). Once the real-time streaming communication terminates, any post real-time asset listing may be distributed to the participants (step 332). The operation then terminates.

It should be appreciated that while the above illustrative embodiments are described in terms of speech and automatic speech recognition during real-time streaming communications, the illustrative embodiments are not limited to such. Rather, in other illustrative embodiments, where textual communication is performed initially, the mechanisms of the illustrative embodiments may operate similarly but without the need to perform automatic speech recognition to generate textual representations. That is, the NLP mechanisms and other components of the ART-AID system 200 may operate similarly, but on the text input by the user directly.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining, in real-time, a textual representation of a user's input during a real-time streaming communication via a real-time streaming communication application;
automatically executing, as part of a background process to the real-time streaming communication, computer natural language processing on the textual representation to identify one or more key terms or key phrases from the textual representation, wherein the computer natural language processing is specifically configured to identify key terms or key phrases corresponding to references to assets;
automatically generating, as part of the background process, one or more search queries to search for a matching asset based on the identified one or more key terms or key phrases;
automatically executing, as part of the background process, the one or more search queries to identify a matching asset; and
presenting, as part of the real-time streaming communication, the matching asset to participant computing devices of the real-time streaming communication.

2. The method of claim 1, wherein the user's input is speech input and wherein the textual representation is generated by performing automatic speech recognition on the speech input.

3. The method of claim 1, wherein the one or more search queries are executed in a hierarchical manner with an expanding scope at each level of the hierarchy.

4. The method of claim 3, wherein the hierarchy comprises, in the following order, a historical asset log storing entries for historical asset accesses and references made by a user, a local storage, and a non-local storage.

5. The method of claim 4, wherein the non-local storage comprises at least one of a cloud storage associated with the user or an organization with which the user is associated, or source computing systems on a wide area network.

6. The method of claim 1, wherein automatically executing, as part of a background process to the real-time streaming communication, computer natural language processing on the textual representation to identify one or more key terms or key phrases from the textual representation comprises processing the textual representation by a fine-tuned language computer model that is fine-tuned to identify references to assets in text.

7. The method of claim 1, wherein presenting, as part of the real-time streaming communication, the matching asset to participant computing devices of the real-time streaming communication comprises:
outputting a request to the user, via a user computing device, for permission to share the asset with the other participant computing devices; and
transmitting one of a link to a location of the asset or the asset to the participant computing devices to the participant computing devices in response to the user providing permission to share the asset.

8. The method of claim 1, wherein presenting, as part of the real-time streaming communication, the matching asset to participant computing devices of the real-time streaming communication comprises automatically inserting a user selectable link to the asset in a textual interface associated with the real-time streaming communication.

9. The method of claim 1, wherein presenting, as part of the real-time streaming communication, the matching asset to participant computing devices of the real-time streaming communication comprises automatically transmitting the asset to the participant computing devices.

10. The method of claim 1, wherein the real-time streaming communication is a web conference provided via a web conferencing application and a web conferencing service provider.

11. A computer program product comprising:
one or more computer-readable storage media; and
program instructions stored on the one or more computer-readable storage media to perform operations comprising:
obtaining, in real-time, a textual representation of a user's input during a real-time streaming communication via a real-time streaming communication application;
automatically executing, as part of a background process to the real-time streaming communication, computer natural language processing on the textual representation to identify one or more key terms or key phrases from the textual representation, wherein the computer natural language processing is specifically configured to identify key terms or key phrases corresponding to references to assets;
automatically generating, as part of the background process, one or more search queries to search for a matching asset based on the identified one or more key terms or key phrases;
automatically executing, as part of the background process, the one or more search queries to identify a matching asset; and
automatically presenting, as part of the real-time streaming communication, the matching asset to participant computing devices of the real-time streaming communication.

12. The computer program product of claim 11, wherein the user's input is speech input and wherein the textual representation is generated by performing automatic speech recognition on the speech input.

13. The computer program product of claim 11, wherein the one or more search queries are executed in a hierarchical manner with an expanding scope at each level of the hierarchy.

14. The computer program product of claim 13, wherein the hierarchy comprises, in the following order, a historical asset log storing entries for historical asset accesses and references made by a user, a local storage, and a non-local storage.

15. The computer program product of claim 14, wherein the non-local storage comprises at least one of a cloud storage associated with the user or an organization with which the user is associated, or source computing systems on a wide area network.

16. The computer program product of claim 11, wherein automatically executing, as part of a background process to the real-time streaming communication, computer natural language processing on the textual representation to identify one or more key terms or key phrases from the textual representation comprises processing the textual representation by a fine-tuned language computer model that is fine-tuned to identify references to assets in text.

17. The computer program product of claim 11, wherein presenting, as part of the real-time streaming communication, the matching asset to participant computing devices of the real-time streaming communication comprises:
outputting a request to the user, via a user computing device, for permission to share the asset with the other participant computing devices; and
transmitting one of a link to a location of the asset or the asset to the participant computing devices to the participant computing devices in response to the user providing permission to share the asset.

18. The computer program product of claim 11, wherein presenting, as part of the real-time streaming communication, the matching asset to participant computing devices of the real-time streaming communication comprises automatically inserting a user selectable link to the asset in a textual interface associated with the real-time streaming communication.

19. The computer program product of claim 11, wherein presenting, as part of the real-time streaming communication, the matching asset to participant computing devices of the real-time streaming communication comprises automatically transmitting the asset to the participant computing devices.

20. A computer system comprising:
a processor set;
one or more computer-readable storage media; and
program instructions stored on the one or more computer-readable storage media to cause the processor set to perform operations comprising:
obtaining, in real-time, a textual representation of a user's input during a real-time streaming communication via a real-time streaming communication application;
automatically executing, as part of a background process to the real-time streaming communication, computer natural language processing on the textual representation to identify one or more key terms or key phrases from the textual representation, wherein the computer natural language processing is specifically configured to identify key terms or key phrases corresponding to references to assets;
automatically generating, as part of the background process, one or more search queries to search for a matching asset based on the identified one or more key terms or key phrases;
automatically executing, as part of the background process, the one or more search queries to identify a matching asset; and
presenting, as part of the real-time streaming communication, the matching asset to participant computing devices of the real-time streaming communication.
